(19) United States
(12) Patent Application Publication
(10) Pub. No.: US 2005/0171974 A1
(43) Pub. Date: Aug. 4, 2005

(54) Method and arrangement for evaluating images taken with a fundus camera

(76) Inventor: Axel Doering, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/517,289

(22) PCT Filed: Feb. 28, 2003
(86) PCT No.: PCT/EP03/02098

(30) Foreign Application Priority Data
Jun. 7, 2002 (DE) 10225855.4

(51) Int. Cl. G06F 7/00

(52) U.S. Cl. 707/104.1

(57) ABSTRACT

Method and arrangement for evaluating images recorded with a fundus camera, wherein deviations from a stored comparison image and/or from a standard image created by evaluating a plurality of comparison images are determined, and/or a similarity analysis is carried out by means of a stored comparison image and/or by means of a standard image created by evaluating a plurality of comparison images.

### CROSS-REFERENCE TO RELATED APPLICATIONS

This application claims priority of International Application No. PCT//EP03/02098, filed Feb. 28, 2003, and German Application No. 102 25 855.4, filed Jun. 7, 2002, the complete disclosures of which are hereby incorporated by reference.

### BACKGROUND OF THE INVENTION

Digital image capture and archiving systems for image-generating methods have become widespread in ophthalmology in recent years. At the same time, image-oriented medical teaching materials and documentation (atlases) are being published in digital and sometimes in multimedia and interactive form to an increasing extent. However, the only exchange of information between image capture systems and atlases, if any, is indirect. In particular, the user is solely responsible for the selection of relevant entries and pictorial examples of the atlas, i.e., the information available in the actual state of the image capture system (e.g., type of directly acquired images, classification of pathological changes that can be detected on the latter, and the like) are not used to filter the information offered by the atlas. On the other hand, it is not possible to expand the atlas through one's own documented photographs or to use documented images of the information system to add to the patient history. Therefore, the usefulness of these information systems for the routine work of the physician and the (manageable) scope of such atlases is severely limited.

### OBJECT OF THE INVENTION

The primary object of the present invention is a method and an arrangement which make it possible to link an image-oriented medical information system (hereinafter: atlas) with a digital image capture and archiving system for ophthalmology in such a way that
(a) it is possible to immediately access the information of the atlas while using the image capture system;
(b) information derived from the actual state of the image capture and archiving system (hereinafter: contextual information) can be used to compose a selection from information to be provided by the atlas that is relevant for the actual work of the user;
(c) the atlas can be expanded by documented photographs provided by the user of the image capture and archiving system;
(d) documented photographs from the atlas can be transferred to the electronic patient records of the image archiving system in order, for example, to document conformity to or deviation from typical clinical phenomena.

### BRIEF DESCRIPTION OF THE DRAWINGS

In the drawings:

FIG. 1 is a block diagram of an image capture system in accordance with the invention; and

FIG. 2 is a flow chart of steps in the method according to the invention.

### DESCRIPTION OF THE PREFERRED EMBODIMENTS

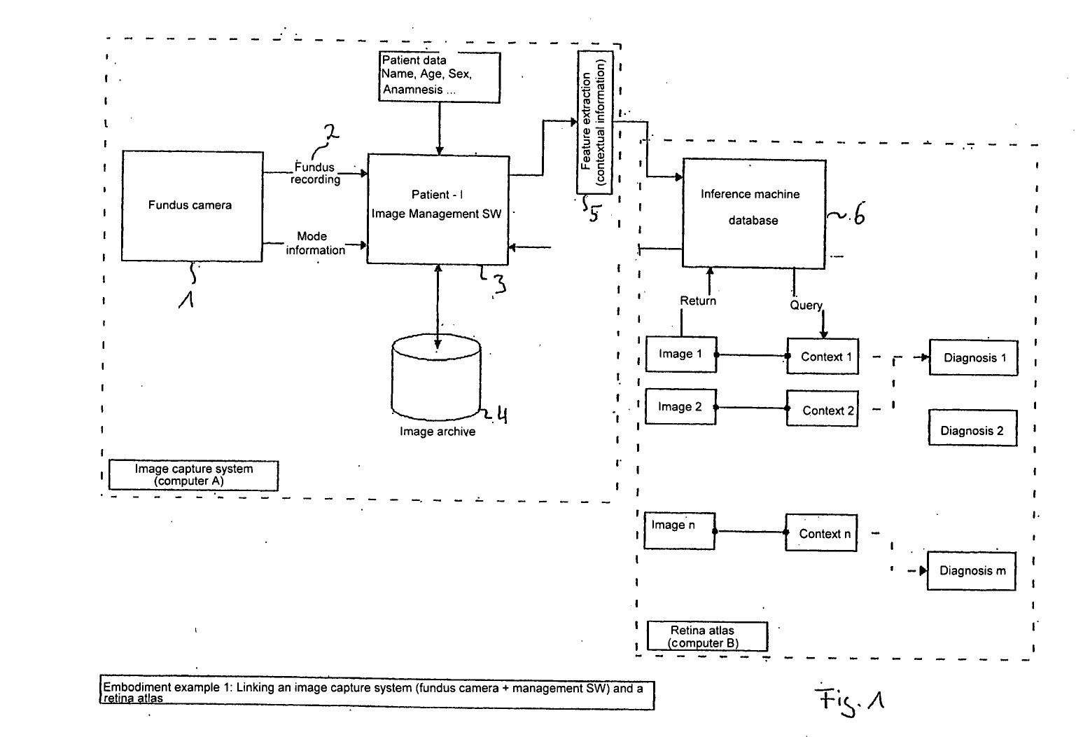

The model (shown in FIG. 1) comprises an image capture system which is connected to a fundus camera and combined with an image archiving system (Figure) which is to be linked to an atlas of fundus photographs (hereinafter: retina atlas) that is installed on the same computer ( . . . ). By means of a program running on this computer for controlling the image capture system which has simultaneous access to the information of the image archiving system, it is possible to start the retina atlas on this computer or on a remote computer to which there is a network connection, to transfer contextual information and to initiate searches (Figure). In addition to this infrastructure, the invention claims the suitable selection of contextual information and the application of a method which enables a fuzzy search for corresponding entries in the retina atlas.

By way of example, FIG. 1 shows the arrangement, according to the invention, comprising a fundus camera 1 for photographing the fundus, for example, a Zeiss FF 450+ fundus camera, whose photographic unit (CCD camera) has an output 2 for sending the photographed fundus images in direction of an evaluating unit 3 which digitizes the recorded images and stores them in a memory or storage 4 (image archive). The images are examined by the evaluating unit 3 for determined structures or features, for example, through gray-value analysis and a gray-value histogram, through color analysis and a color histogram, or through detection of characteristic structures (example).

A comparison operator 5 is connected to an internal or external database 6, which can be, for example, a retina atlas according to (reference source) as a CD-ROM or an internet database, and compares images recorded by the fundus camera to images that have already been recorded or archived on the basis of the analyzed criterion (color, gray value, structure). These images can be fundus images of other eyes from pre-stored archives or images of one and the same patient that were recorded earlier.

Further, the comparison operator 5 can create a new data storage for the recorded image and use it later for purposes of comparison. This is particularly important when:
(a) the recorded image has features that conform only partly, or not at all, to stored images with respect to the image analysis and it is stored for detection of a new pathology image;
(b) the recorded image is to serve as a basis for a subsequent comparison with newly recorded images.

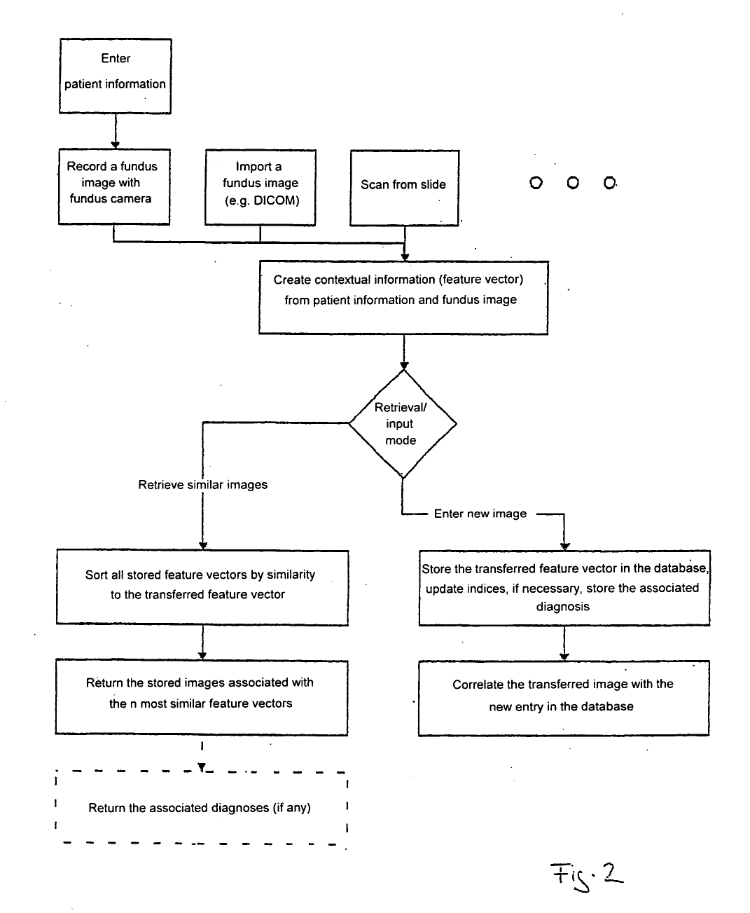

FIG. 2 schematically shows the flow of the method according to the invention which comprises:
entering patient-specific information for subsequent identification of the recorded image that is stored together with this information;
taking a picture with the fundus camera;
importing one or more pre-stored images from internal or external storage media (computer, CD-ROM, Internet);
producing contextual information through image analysis of at least the recorded image;
analyzing pre-stored image according to the same or similar criteria to form contextual information of the pre-stored images. This can also be carried out by averaging a plurality of images or image groups for generating standard contextual information;
comparing the recorded images with pre-stored images by comparing the contextual information for determining a diagnosis or classifying the recorded image;
(retrieving similar images); and
storing (new entry) the contextual information that is associated with the recorded image through comparison together with the image for correlating with a diagnosis or classification.

According to the invention, an image analysis for classification and for forming contextual information is also carried out for data that are purchased or viewable on the Internet (Zeiss Retina Atlas: http://www.zeiss.de/czj/de/op/zeiss/index_frames.html).

Compilation of Contextual Information:

Contextual information is drawn from
the evaluation of the settings of the fundus camera (recording mode, field angle, exposure settings) that are either actually taken from the connected camera or are taken as entries from the image archive;
manual annotations associated with the picture (keywords, diagnostic codes, pictorial elements inserted in determined positions in the picture);
the evaluation of patient-specific information (age, sex, anamnesis, etc.);
the evaluation of the image content.

The last item comprises a large number of general methods that can be used for any image contents and specific methods for detecting and analyzing typical objects and changes in the ocular fundus. The first method class (see also [1], [2], [3]) includes:
determination of color histograms and parameters derived therefrom;
evaluation of spatial distribution of determined color values or gray values.

The second method class (see [4], [5], [6]) comprises, for example:
extraction of the vascular network and derivation of characteristic quantities (e.g., length ratio of large to small vessels, degree of arborization);
classification and quantification of structures at the ocular fundus (e.g., papilla, fovea); and
detection and quantification of pathological changes (e.g., position and extension of exudates, microaneurysms, scars or neovascularizations) which can be carried out depending on the determined fundus camera settings.

Accordingly, a set of attributes that encompasses the actual field of interest for inquiries of the retina atlas can be produced either for the actually selected image (the results of the image capture or of a query of the image archive) or for the actually selected patient (by evaluating and combining this information for a plurality of recordings), e.g., in the following form:

TABLE 1
Possible attribute vector for a fundus recording

| | |
|---|---|
| Age | 58 |
| Sex | male |
| Anamnesis | diabetes II |
| Image type | color |
| Pathology | 15 microaneurysms in 3 quadrants, |
| | average diameter xmm, |
| | 9 hard exudates, total surface area xmm² |

Search Method in Retina Atlas:

For the attributes given above, images that belong to the same topic range are searched from the retina atlas and ordered according to similarity so that the user does not have to search manually through a large number of images. To take the example of the attribute vector according to Table 1, all pictures are found for nonproliferative diabetic retinopathy. This presupposes that corresponding attributes have already been determined for all of the images acquired in the retina atlas. The degrees of similarity to the given attribute vector can then be determined and a correspondingly sorted amount of image hits or a chapter or section of the retina atlas receiving the most hits can be returned by means of hierarchical search methods ([7], [8]).

The corresponding images (or the corresponding chapter) are loaded and displayed in the retina atlas.

Expansion of the Retina Atlas by Self-Prepared Images:

The user of the image capture and archiving system has the possibility of annotating self-prepared images (or images taken from the image archive) and adding them to the retina atlas by incorporating them in existing chapters or by creating new chapters or sections. When the images are transferred, the attributes are generated automatically and the image index is updated so that these new images are available for future searches in the retina atlas.

Importing Images and Comments from the Retina Atlas:

It is possible for the user to transfer selected images from the retina atlas to patient files in the image archiving system for purposes of documentation by means of an operator control function of the retina atlas.

References of the Relevant Art
[1] Yamamoto et al., “Extraction of Object Features and Its Application to Image Retrieval”, Trans. of IEICE, vol. E72, No. 6, 771-781 (June 1989).
[2] M. Kurokawa, “An Approach to Retrieving Images by Using their Pictorial Features”, IBM Research, Japan, September 1989.
[3] Gudivada, V. N., Raghavan, V. V. (editors), “Content-based image retrieval systems”, IEEE Computer 28 (9), 18-22 (1995).
[4] Kirkpatrick et al., “Quantitative Image Analysis of Macular Drusen from Fundus Photographs and Scanning Laser Ophthalmoscope Images”, Eye (9) 48-55, 1995.
[5] S. Feman et al., “A Quantitative System to Evaluate Diabetic Retinopathy from Fundus Photographs”, Investigative Ophthalmology and Visual Science, (36): 174-180, 1995.
[6] E. Peli, M. Lahav, “Drusen Measurement from Fundus Photographs Using Computer Image Analysis”, Ophthalmology 93:1575-1580, 1986.
[7] Hanan Samet, “The Quadtree and related Hierarchical Data Structures”, Computing Surveys, vol. 16,No. 2, June 1984.
[8] S. Berchthold et al., “The X-Tree: An Index structure for high-dimensional data”, Proceedings of the International Conference on Very Large Databases, 28-29, 1996.
[9] E. Petrakis, C. Faloutsos, “Similarity searching in medical image databases”, IEEE Trans. Knowledge and Data Engineering, 9(3):435-447, 1997.

Patents:
U.S. Pat. No. 5,579,471
U.S. Pat. No. 5,852,823
U.S. Pat. No. 5,913,205
U.S. Pat. No. 5,911,139

While the foregoing description and drawings represent the present invention, it will be obvious to those skilled in the art that various changes may be made therein without departing from the true spirit and scope of the present invention.

1-6. (canceled)

7. A method for evaluating images recorded with a fundus camera, comprising the steps of:
determining deviations from a stored comparison image and/or from a standard image created by evaluating a plurality of comparison images, and/or
carrying out a similarity analysis by a stored comparison image and/or by a standard image created by evaluating a plurality of comparison images.

8. The method according to claim 7, wherein the evaluation is carried out by averaging extracted features.

9. The method according to claim 7, wherein deviations are determined and/or the similarity analysis is carried out on the basis of a gray-value analysis and/or an analysis of color histograms and/or a structure analysis.

10. The method according to claim 7, wherein an extraction of vascular tree parameters is carried out.

11. An arrangement for the evaluation of images recorded with a fundus camera, comprising:
a fundus camera for recording the ocular fundus;
an image storage for storing recorded fundus images; and
means for evaluating the recorded fundus images further comprising means for gray-value analysis and/or means for preparing color histograms and/or means for structure analysis.

12. The arrangement according to claim 11 for carrying out the method of claim 7.

13. An arrangement according to claim 11, wherein means are provided for determining deviations from a stored comparison image and/or from a standard image created by evaluating a plurality of comparison images, and/or means are provided for similarity analysis by a stored comparison image and/or a standard image created by evaluating a plurality of comparison images.
